(19) United States
(12) Patent Application Publication
(10) Pub. No.: US 2012/0103310 A1
(43) Pub. Date: May 3, 2012

(54) APPARATUS FOR CONNECTING INTAKE AND EXHAUST VALVES FOR INTERNAL COMBUSTION ENGINE

(76) Inventor: Kum Ki, Chungcheongnam-do (KR)

(21) Appl. No.: 13/256,156

(22) PCT Filed: Feb. 9, 2010
(86) PCT No.: PCT/KR10/00788

§ 371 Date: Sep. 12, 2011

(30) Foreign Application Priority Data
Mar. 12, 2009 (KR) 10-2009-0021291

(51) Int. Cl. F02B 33/44; F02B 33/06

(52) U.S. Cl. 123/559.2

(57) ABSTRACT

The present invention relates to reduction of compression space and improvement of intake/exhaust efficiencies through structural modification of a booster cylinder that delivers an explosive exhaust pressure generated during an exhaust stroke of one cylinder in a multi-cylinder internal combustion engine to an intake pressure of another cylinder, to minimize frictional heat and abrasion due to the reciprocating motion of a piston of the booster cylinder, and to endure a damping force by an air pocket when the piston of the booster cylinder moves toward the exhaust side. The apparatus for connecting intake and exhaust valves for internal combustion engines according to the present invention comprises: a plurality of cylinders such that when one cylinder is on an exhaust stroke, at least another cylinder synchronously performs at least part of an intake stroke; a pressure delivery pipe for connecting an exhaust manifold of one of the plurality of cylinders to an intake manifold of another cylinder; a booster pump installed in the pressure delivery pipe, wherein the booster cylinder, in which the piston of the booster pump is reciprocally and movably embedded, is comprised of a head having a first through-hole communicating with the intake side of the pressure delivery pipe and a recess for reducing the compression space as the piston moves toward the intake side, and a body fixed to the head, the body having a second through-hole communicating with the exhaust side of the pressure delivery pipe.

### CROSS-REFERENCE TO RELATED APPLICATIONS

This application is a National Phase Entry of PCT Patent Application No. PCT/KR2010/000788 filed 9 Feb. 2010, and claims priority to Korean Patent Application No. 10-2009-0021291 filed 12 Mar. 2009.

### TECHNICAL FIELD

The present invention relates to an apparatus for connecting intake and exhaust valves for an internal combustion engine that is applicable to a multi-cylinder internal combustion engine having plural cylinders, in which when one cylinder is on an exhaust stroke, at least another cylinder is synchronous to perform at least part of an intake stroke. More particularly, the present invention relates to an apparatus for connecting intake and exhaust valves for an internal combustion engine, which can reduce a compression space and thus improve intake/exhaust efficiencies through structural modification of a boost cylinder that delivers explosive exhaust pressure generated during an exhaust stroke of one cylinder in a multi-cylinder internal combustion engine to another cylinder as intake pressure, minimize frictional heat and abrasion due to a reciprocating motion of a piston of the booster cylinder, and secure a damping force through an air pocket when the piston of the booster cylinder moves toward the exhaust side.

### BACKGROUND ART

As illustrated in FIG. 1, an apparatus for connecting intake and exhaust valves for a multi-cylinder internal combustion engine in the related art is described in Korean Patent Application No. 10-1993-12987 filed by the applicant, which discloses a multi-cylinder (four-cylinder (which uses four booster pumps)) internal combustion engine having plural cylinders, in which when one cylinder is on an exhaust stroke, at least another cylinder is synchronous to perform at least part of an intake stroke, including pressure delivery pipes 3 and 4 having both ends which are branched on an exhaust manifold of one cylinder 1 and on an intake manifold of another cylinder 2, respectively, to connect the two paths; and a booster pump 5 installed in the middle of the pressure delivery pipes 3 and 4 to increase the intake current speed of the intake manifold by the exhaust pressure of the exhaust manifold.

The above-described booster pipe 5 includes a booster cylinder 6 having both ends which communicate with the intake side and the exhaust side of the pressure delivery pipes, respectively, and a piston 7 that is elastically biased toward the exhaust side by a predetermined resilient force in the booster cylinder 6.

In the drawing, unexplained reference numerals “1a” and “1b” denote an intake port and an exhaust port formed on an upper portion of the cylinder 1, respectively, “2a” and “2b” denote an intake port and an exhaust port formed on an upper portion of the cylinder 2, respectively, “8” denotes a pressure setting spring elastically biasing the piston 7 toward the exhaust side, and “9” denotes a damping spring damping an impact that is generated when the piston 7 collides with an end portion wall of the booster cylinder 6.

According to the apparatus for connecting intake and exhaust valves in the related art, since the piston 7 performs a reciprocating motion at high speed in a state where the piston 7 is in close contact with the inner wall surface of the booster cylinder 6, the durability is lowered due to frictional heat and abrasion generated during the reciprocating motion of the piston 7, and thus the lifespan is shortened.

Further, although the damping spring 9 is used to damp the impact when the piston 7 collides with the end portion wall of the booster cylinder 6, it is a difficult work to set the respective elastic forces of the pressure setting spring 8 and the damping spring 9 which have different elastic forces. Due to this, the durability is lowered due to the impact that is generated during the repeated reciprocating motion of the piston 7.

### DISCLOSURE

### Technical Problem

Therefore, the present invention has been made in view of the above-mentioned problems, and an embodiment of the present invention is related to an apparatus for connecting intake and exhaust valves for an internal combustion engine, which can improve intake/exhaust efficiencies through forming of a structure in a recessed manner so that a compression space is reduced, which is formed by a piston inside a booster cylinder that delivers explosive exhaust pressure generated during an exhaust stroke of one cylinder in the multi-cylinder internal combustion engine to another cylinder as intake pressure.

An embodiment of the present invention is related to an apparatus for connecting intake and exhaust valves for an internal combustion engine, in which a heat dissipation fin is formed on an outer wall of the booster cylinder and an oil path is formed between the piston and the boost cylinder so as to minimize the friction and abrasion due to the reciprocating motion of the piston of the boost cylinder.

An embodiment of the present invention is related to an apparatus for connecting intake and exhaust valves for an internal combustion engine, which can protect a piston from an impact through an air pocket that is formed between the booster cylinder and the piston when the piston of the booster cylinder moves toward the exhaust side.

### Technical Solution

In one embodiment of the present invention, there is provided an apparatus for connecting intake and exhaust valves for a multi-cylinder internal combustion engine, which includes plural cylinders, in which when one cylinder is on an exhaust stroke, at least another cylinder is synchronous to perform at least part of an intake stroke, pressure delivery pipes connecting an exhaust manifold of the one cylinder to an intake manifold of the other cylinder of the plural cylinders, and a booster pump installed on the pressure delivery pipes, wherein a booster cylinder, in which a piston of the booster pump is installed to perform a reciprocating motion, includes a head having a first through-hole formed thereon to communicate with the intake side of the pressure delivery pipes and a recessed portion formed thereon to reduce a compression space when the piston moves toward the intake side; and a main body fixed to the head, and having a second through-hole formed thereon to communicate with the exhaust side of the pressure delivery pipes.

The apparatus for connecting intake and exhaust valves according to an embodiment of the present invention may further include a projection portion for a cushion that is formed on the piston to correspond to the second through-hole so as to control the discharge of air pressure from the booster cylinder.

The apparatus for connecting intake and exhaust valves according to an embodiment of the present invention may further include an oil path that is formed between an outer wall of the piston and an inner wall of the booster cylinder by upper and lower stepped portions formed on the outer wall of the piston to be in close contact with the inner wall of the booster cylinder, so that lubrication is performed by oil that is supplied to the oil path through an oil injection hole formed on the booster cylinder while the piston performs the reciprocating motion.

The apparatus for connecting intake and exhaust valves according to an embodiment of the present invention may further include a damping member mounted on a head bottom surface to absorb an impact due to collision of the piston with the head of the booster cylinder when the piston moves to a top dead point.

The apparatus for connecting intake and exhaust valves according to an embodiment of the present invention may further include a heat dissipation fin formed on the outer wall of the booster cylinder.

A bottom surface of the booster cylinder and a bottom surface of the piston that is in close contact with the bottom surface of the booster cylinder may be formed as inclined surfaces so as to smoothly discharge air from the inside of the booster cylinder when the piston moves to a bottom dead center.

### Advantageous Effects

The apparatus for connecting intake and exhaust valves for an internal combustion engine according to an embodiment of the present invention has the following advantages.

The intake/exhaust efficiencies can be improved through forming of the structure in a recessed manner so that the compression space is reduced, which is formed by the piston inside the booster cylinder that delivers explosive exhaust pressure generated during an exhaust stroke of one cylinder in the multi-cylinder internal combustion engine to another cylinder as intake pressure.

Further, the heat dissipation fin is formed on the outer wall of the booster cylinder and the oil path is formed between the piston and the boost cylinder, so that the friction and abrasion due to the high-speed reciprocating motion of the piston of the boost cylinder can be reduced.

Further, since the piston is protected from an impact through then air pocket that is formed between the booster cylinder and the piston when the piston of the booster cylinder moves toward the exhaust side, the lifespan can be extended.

### BRIEF DESCRIPTION OF THE DRAWINGS

The foregoing and other objects, features and advantages of the present invention will become more apparent from the following detailed description when taken in conjunction with the accompanying drawings in which:

FIG. 1 is a schematic view illustrating an apparatus for connecting intake/exhaust valves for a multi-cylinder internal combustion engine in the related art;

FIG. 2 is a cross-sectional view illustrating main parts of an apparatus for connecting intake/exhaust valves for an internal combustion engine according to an embodiment of the present invention;

FIG. 3 is a cross-sectional view illustrating an apparatus for connecting intake/exhaust valves for an internal combustion engine according to an embodiment of the present invention;

FIG. 4 is a view illustrating an apparatus for connecting intake/exhaust valves for an internal combustion engine in a first operation state; and

FIG. 5 is a view illustrating an apparatus for connecting intake/exhaust valves for an internal combustion engine in a second operation state according to an embodiment of the present invention.

### DESCRIPTION OF REFERENCE NUMERALS IN THE DRAWING

1: first through-hole
12: recessed portion
13: head
14: second through-hole
15: main body
16: booster cylinder
17: projection portion
18: piston
19: elastic member
20: booster pump
21: stepped portion
22: stepped portion
23: oil path
24: oil injection hole
25: damping member
26: heat dissipation fin
27: piston ring
28: nipple
29: hose

### BEST MODE

Hereinafter, preferred embodiments of the present invention will be described in detail with reference to the accompanying drawing. It is to be understood that the following examples are illustrative only for those of ordinary skill in the field to which the present invention pertains and thus the present invention is not limited thereto.

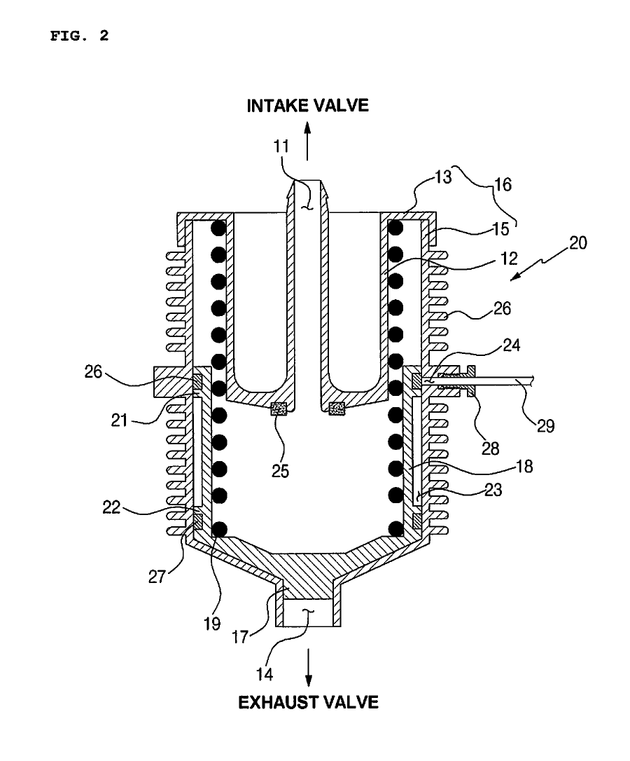

As illustrated in FIGS. 2 to 5, an apparatus for connecting intake and exhaust valves for a multi-cylinder internal combustion engine includes plural cylinders, in which when one cylinder is on an exhaust stroke, at least another cylinder is synchronous to perform at least part of an intake stroke, pressure delivery pipes connecting an exhaust manifold of the one cylinder to an intake manifold of the other cylinder of the plural cylinders, and a booster pump installed on the pressure delivery pipes, wherein a booster cylinder 16, in which a piston 18 of the booster pump 20 is installed to perform a reciprocating motion, includes a head 13 having a first through-hole 11 formed thereon to communicate with the intake side of the pressure delivery pipes 3 and 4 and a recessed portion 12 formed thereon to reduce a compression space when the piston 18 moves toward the intake side; and a main body 15 fixed to the head 13, and having a second through-hole 14 formed thereon to communicate with the exhaust side of the pressure delivery pipes 3 and 4.

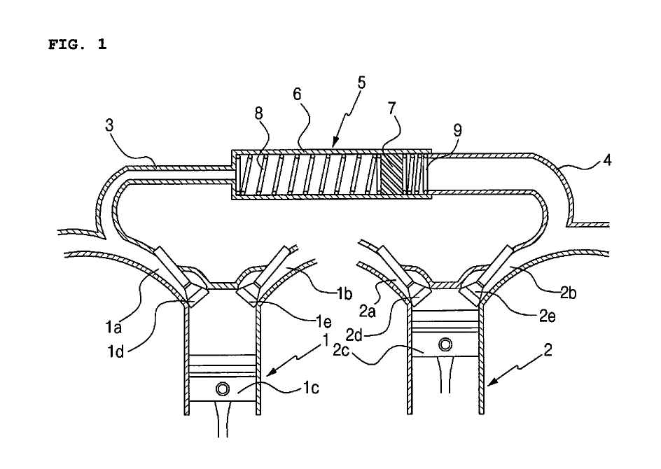

Since the construction, except for the head 13 having the recessed portion 12 formed thereon to reduce a compression space, and the booster pump 20 having the piston 18 that forms an air pocket for damping an impact between the piston 18 and the booster cylinder 16 when the piston 18 moves to a down dead center, is substantially the same as that of the apparatus for connecting intake and exhaust valves for an internal combustion engine illustrated in FIG. 1, the detailed description of the construction and operation thereof will be omitted, and duplicate reference numerals are denoted in the same manner.

An oil path 23 is formed between an outer wall of the piston 18 and an inner wall of the booster cylinder 16 by upper and lower stepped portions 21 and 22 formed on the outer wall of the piston 18 to be in close contact with the inner wall of the booster cylinder 16, and lubrication is performed by oil that is supplied to the oil path 23 through an oil injection hole 24 formed on the booster cylinder 16 while the piston 18 performs the reciprocating motion.

A damping member 25 (a rubber material is used) is mounted on a bottom surface of the head 13 to absorb an impact due to collision of the piston 18 with the head 13 of the booster cylinder 16 when the piston 18 moves to a top dead point.

A heat dissipation fin 26 is formed on the outer wall of the booster cylinder 16.

A bottom surface of the booster cylinder 16 and a bottom surface of the piston 18 that is in close contact with the bottom surface of the booster cylinder 16 are formed as inclined surfaces so as to smoothly discharge air from the inside of the booster cylinder 16 when the piston 18 moves to a bottom dead center.

In the drawing, unexplained reference numerals “26” and “27” denote piston rings that prevent oil from the oil path 23 from leaking, “28” denotes a nipple fixing a hose 29 for supplying the oil to the oil path 23 through the oil injection hole 24 to the booster cylinder 16, and “19” denotes an elastic member elastically biasing the movement of the piston 18 to the bottom dead center to an initial state by pressing the piston 18 against the booster cylinder 16.

Hereinafter, use examples of the apparatus for connecting intake and exhaust valves for an internal combustion engine according to an embodiment of the present invention will be described in detail with reference to the accompanying drawing.

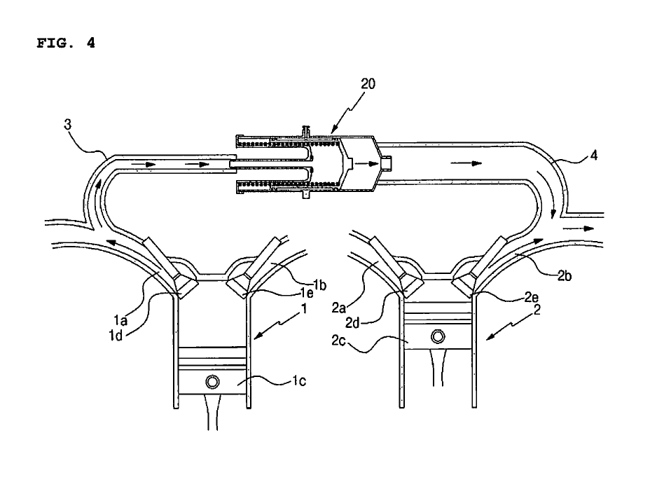

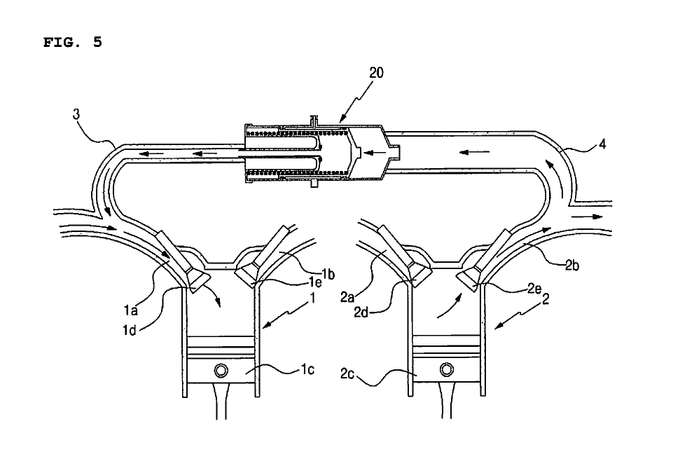

In FIGS. 4 and 5, a cylinder 1 and a cylinder 2 are synchronous with each other in an intake stroke and an exhaust stroke.

FIG. 4 illustrates the state where the piston 18 in the booster cylinder 16 is returned to the exhaust side after the intake stroke and the exhaust stroke are finished. A piston 1c of the cylinder 1 is in the bottom dead center, and an intake valve 1d and an exhaust valve 1e are in a closed state. A piston 2C of the above-described cylinder 2 is at the top dead point, and an intake valve 2d and an exhaust valve 2e are in a closed state.

In the exhaust side pressure delivery pipe 3 and the exhaust side of the booster cylinder 16, mixed gas that remains after the intake thereof to the cylinder 1 is filled, and the piston 18 is returned to the exhaust side by the restoring force of the elastic member 19. Thereafter, three strokes of compression, expansion, and exhaust are performed in the cylinder 1, and three strokes of intake, compression, and expansion are performed in the cylinder 2.

FIG. 5 illustrates a state after the cylinder 1 and the cylinder 2 start the intake stroke and the exhaust stroke, respectively. An exhaust valve 2e of the cylinder 2 is open, the piston 2c ascends, and high-temperature and high-pressure exhaust gas is discharged to the exhaust port 2b. At this time, the exhaust gas also flows into the exhaust side pressure delivery pipe 4, and thus the piston 18 in the booster cylinder 16 moves to the intake side at high speed. The mixed gas in the intake side of the booster cylinder 16 flows to the intake port 1a at high speed. This flow of the mixed gas increases the speed and the amount of the intake air that flows into the cylinder 1.

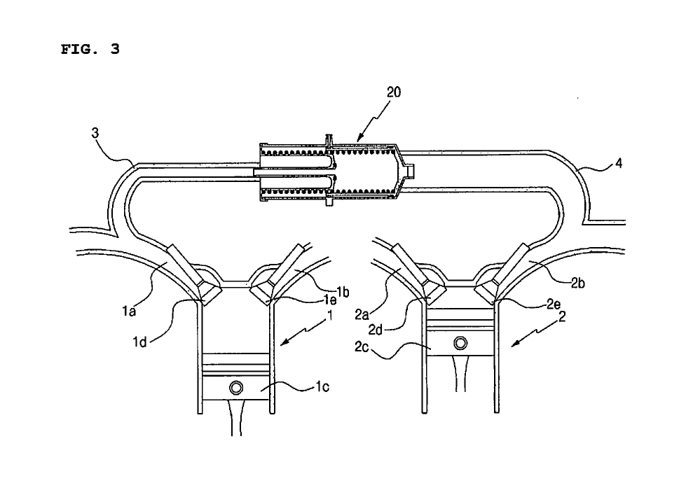

Thereafter, if the intake stroke and the exhaust stroke of the cylinder 1 and the cylinder 2 are finished, the state illustrated in FIG. 4 is repeated again to return to the state illustrated in FIG. 3. If the exhaust valve 2e of the cylinder is closed and the pressure in the exhaust port 2b is lowered, the piston 18 in the booster pump 20 is returned to the exhaust side by the restoring force of the elastic member 19, and the mixed gas is filled again in the intake side of the booster cylinder 16 to complete one cycle.

On the other hand, in the case where the piston 18 slides in the booster cylinder 16 to perform a reciprocating motion, the frictional heat and abrasion generated on the outer wall surface of the piston 18 and the inner wall surface of the booster cylinder 16 can be minimized by the oil (lubricating oil) that is supplied to the oil path 23 formed on the outer wall surface of the piston 18 through the hose 29 (as illustrated in FIG. 1, the frictional heat and abrasion are generated due to the close contact of the outer wall surface of the piston 7 with the inner wall surface of the booster cylinder 6 during the reciprocating motion of the piston 7 in the booster cylinder 6).

When the piston 18 moves to the bottom dead center, the second through-hole 14 formed on the bottom surface of the booster cylinder 16 is coupled to the projection portion 17 for a cushion formed on the piston to correspond to the second through-hole 14, and thus the discharge of air pressure from the booster cylinder 16 to the exhaust side pressure delivery pipe 4 can be adjusted (the moving speed of the piston 18 is reduced). When the piston 18 moves to the bottom dead center, the impact generated due to the mutual collision of the piston 18 and the booster cylinder 16 can be damped by the air pocket formed between the piston 18 and the booster cylinder 16.

When, the piston 18 moves to the top dead point, the damping member 25 (a rubber material is used) formed on the bottom surface of the recessed portion 12 can protect the piston 18 from the impact that is generated due to the collision of the piston 18 with the recessed portion 12.

### INDUSTRIAL APPLICABILITY

As described above, the apparatus for connecting intake and exhaust valves for an internal combustion engine according to an embodiment of the present invention has the following advantages.

The structure is formed in a recessed manner so that the compression space is reduced, which is formed by the piston inside the booster cylinder that delivers explosive exhaust pressure generated during an exhaust stroke of one cylinder in the multi-cylinder internal combustion engine to another cylinder as intake pressure, and thus the intake/exhaust efficiencies can be improved.

Further, since the heat dissipation fin is formed on the outer wall of the booster cylinder and the oil path is formed between the piston and the boost cylinder, the friction and abrasion due to the high-speed reciprocating motion of the piston of the boost cylinder can be reduced.

Further, since the piston is protected from an impact through then air pocket that is formed between the booster cylinder and the piston when the piston of the booster cylinder moves toward the exhaust side, the lifespan can be extended.

While this invention has been described in connection with what is presently considered to be the most practical and preferred embodiments, it is to be understood that the invention is not limited to the disclosed embodiment and the drawings. On the contrary, it is intended to cover various modifications and variations within the spirit and scope of the appended claims.

1. In an apparatus for connecting intake and exhaust valves for a multi-cylinder internal combustion engine, including plural cylinders, in which when one cylinder is on an exhaust stroke, at least another cylinder is synchronous to perform at least part of an intake stroke, pressure delivery pipes connecting an exhaust manifold of the one cylinder to an intake manifold of the other cylinder of the plural cylinders, and a booster pump installed on the pressure delivery pipes,
a booster cylinder, in which a piston of the booster pump is installed to perform a reciprocating motion, comprises a head having a first through-hole formed thereon to communicate with the intake side of the pressure delivery pipes and a recessed portion formed thereon to reduce a compression space when the piston moves toward the intake side; and a main body fixed to the head, and having a second through-hole formed thereon to communicate with the exhaust side of the pressure delivery pipes.

2. The apparatus for connecting intake and exhaust valves according to claim 1, further comprising a projection portion for a cushion that is formed on the piston to correspond to the second through-hole so as to control the discharge of air pressure from the booster cylinder.

3. The apparatus for connecting intake and exhaust valves according to claim 1, further comprising an oil path that is formed between an outer wall of the piston and an inner wall of the booster cylinder by upper and lower stepped portions formed on the outer wall of the piston to be in close contact with the inner wall of the booster cylinder, so that lubrication is performed by oil that is supplied to the oil path through an oil injection hole formed on the booster cylinder while the piston performs the reciprocating motion.

4. The apparatus for connecting intake and exhaust valves according to claim 1 or 2, further comprising a damping member mounted on a head bottom surface to absorb an impact due to collision of the piston with the head of the booster cylinder when the piston moves to a top dead point.

5. The apparatus for connecting intake and exhaust valves according to any one of claims 1 to 3, further comprising a heat dissipation fin formed on the outer wall of the booster cylinder.

6. The apparatus for connecting intake and exhaust valves according to claim 1 or 2, wherein a bottom surface of the booster cylinder and a bottom surface of the piston that is in close contact with the bottom surface of the booster cylinder are formed as inclined surfaces so as to smoothly discharge air from the inside of the booster cylinder when the piston moves to a bottom dead center.
